(19) United States
(12) Patent Application Publication
(10) Pub. No.: US 2026/0267612 A1
(43) Pub. Date: Sep. 10, 2026

(54) METHOD AND APPARATUS FOR THE ACCELERATION OF RANDOMIZED WORKLOADS

(71) Applicant: Quside Technologies S.L., Casteldefells (ES)

(72) Inventors: Carlos ABELLÁN SÁNCHEZ, Barcelona (ES); Ismael PÉREZ ROJO, Burgos Burgos (ES); Jose Ramón MARTÍNEZ SAAVEDRA, Barcelona (ES)

(21) Appl. No.: 19/663,385

(22) Filed: Apr. 30, 2026

Related U.S. Application Data
(63) Continuation of application No. PCT/EP2024/080615, filed on Oct. 29, 2024.

(30) Foreign Application Priority Data
Oct. 30, 2023 (EP) 23383107.2

(51) Int. Cl. G06F 7/58

(52) U.S. Cl. CPC G06F 7/58

(57) ABSTRACT

A computing device or system, comprising: a randomness core, a kernel core, and a randomness distribution element; said randomness core delivering one or more random numbers to the randomness distribution element, said randomness distribution element delivering one or more random numbers to the kernel core, said kernel core including said one or more random numbers into one or more computational workloads, and said randomness core and said kernel core being two distinct logical or physical elements. Also, a field-programmable gate array, an integrated circuit board assembly, and a method for post-processing random numbers.

### CROSS-REFERENCE TO RELATED APPLICATION

This is a Continuation of International Application PCT/EP2024/080615, which has an international filing date of October 29, 2024, and the disclosure of which is incorporated in its entirety into the present Continuation by reference. This Continuation also claims foreign priority to European Application EP23383107.2, filed October 30, 2023.

### BACKGROUND

Since their inception, information technologies have acted as radical transformers of the society we live in, both on industrial and everyday levels. Computers have seamlessly integrated into the fabric of modern society, becoming indispensable tools and changing the way we interact with each other and how we work. From healthcare and finance to entertainment and transportation, virtually every sector has experienced a paradigm shift, where data-driving decision-making and computational solutions have become the norm.

This increase in capabilities has also enabled more computationally complex activities that were previously deemed impossible. Calculations and simulations that seemed unfeasible fifty years ago can now be done with the computing power of a cell phone; proportionally, today's supercomputers run extraordinarily complex simulations, exploiting their full computing power, allowing us to improve the efficiency and quality of decision-making to unprecedented limits.

For example, in climate modeling, today's computational capabilities empower scientists to simulate complex climate systems, providing insights into climate change trends and informing mitigation strategies. Likewise, in personalized medicine, computational analysis of individual genomes enables tailored treatment plans and predictive diagnostics that were previously unthinkable. The realm of communications security also stands testament to this progress, with advanced cryptography algorithms ensuring secure transactions and information exchange, a feat made possible by computational capabilities that were once purely speculative.

To sustain this pace, it is mandatory to proportionally increase the effective computing capacities available to us. Historically, computational capacity was increased by using faster processors, or more of them. However, with the demands of today's problems, the limitations of this approach have become evident. Traditional processors, while effective for certain tasks, need help to provide the speed, capacity, efficiency, or latency that today's problems require. Therefore, as the amount of data and complexity of models increases, the need for specialized solutions becomes increasingly apparent.

To address this problem, hardware-based accelerators have entered the scene to complement the capabilities of traditional processors. These accelerators provide specialized circuitry optimized for specific workloads, enhancing the efficiency of all tasks that can benefit from them: from real-time rendering to artificial intelligence.

Since they specialize in a given type of task, different types of accelerators have emerged, each offering a specific architecture suitable for each workload. The best known of these accelerators, graphical processing units (GPUs), have a highly parallelizable architecture, with many cores optimized for simultaneous computation, providing an exceptional platform for workloads requiring massive data parallelism. Examples of such workloads can be found in scientific simulations, machine learning, generative artificial intelligence or cryptography.

Other accelerators that have gained significant traction include application-specific integrated circuits (ASICs) and field-programmable gate arrays (FPGAs). They provide specialized circuitry in conjunction with high levels of power efficiency. The main use cases are in networking and cryptography, where they are typically superior to any other alternative.

In addition to these well-established accelerators, there is a whole series of accelerators that, although they have a lower industrial penetration or readiness level, are promising solutions within the hardware accelerator field. Examples of these are tensor processing units (TPUs), specialized in matrix-vector products, which are crucial in machine learning loads; or quantum processing units (QPUs), which use quantum systems to solve computational problems utilizing quantum properties; for example, in tasks such as optimization and cryptoanalysis.

While designed to excel in specific tasks, hardware accelerators often struggle when applied beyond their intended scope, limiting their adaptability and creating inefficiencies. For instance, an accelerator optimized for real-time video rendering may falter when handling machine learning algorithms or cryptography, leading to compromised performance and suboptimal outcomes. Another example would be an accelerator optimized for large matrix-vector operations, which would be extremely inefficient when running a word processing application.

For example, while GPUs are proficient in graphics rendering, they fall short when it comes to handling real-time physics simulations or other compute-intensive applications, posing a challenge to seamlessly blend computational complexity with real-time performance. Other accelerators, for example, may find themselves unable to handle machine learning workloads, as these rely on vast datasets and the capability of processing those quickly.

Furthermore, for applications like autonomous driving, augmented reality, or real-time risk estimation achieving low-latency performance is essential to minimize the delay between input and output. However, existing hardware accelerators might introduce processing delays due to architectural intricacies or data transfer inefficiencies. Additionally, the demanding computational requirements of modern applications can strain existing accelerators, leading to excessive power consumption.

Beyond the challenges outlined, existing hardware accelerators encounter specific limitations when grappling with the intricate demands of randomness-intensive workloads. These workloads are pivotal across diverse domains such as scientific simulations, cryptographic protocols, and select machine learning tasks.

Their foundational reliance on precise manipulation of random data is critical for their accurate and reliable outcomes. For instance, in scientific simulations, the behavior of complex systems under varying conditions necessitates the injection of randomized variables to emulate real-world scenarios. Similarly, cryptographic protocols hinge on generating and managing random keys to ensure unbreakable encryption, security, and privacy.

GPUs and TPUs excel in parallel processing, yet they lack dedicated circuitry optimized for true random number generation. This deficiency exposes cryptographic applications to potential biases or vulnerabilities, compromising their security and trustworthiness.

Similarly, FPGAs, known for their reconfigurability, may not possess the specialized components required to efficiently generate or process randomness, hampering their performance in simulations or cryptographic protocols.

Also, QPUs, while promising for specific tasks, still need to possess the maturity and precision necessary for reliable randomness generation, limiting their suitability for certain applications.

Finally, ASICs, celebrated for their tailored designs catering to specific applications, encounter challenges when accommodating the inherent uncertainty of randomness-intensive workloads. While their inflexible, specialized architectures can prove advantageous in targeted scenarios, they lack the versatility to handle the intricate and diverse demands of random data manipulation across domains like scientific research, cryptography, and machine learning.

In summary, the existing accelerator landscape stands ill-equipped to meet the finely tuned demands of randomness-intensive workloads. The intricacies emerging from the inherent unpredictability and variability of randomness have received limited attention within the boundaries of conventional acceleration paradigms.

As these workloads proliferate across pivotal domains, the call for a novel hardware accelerator paradigm-one meticulously crafted to surmount the obstacles posed by randomness-intensifies more than ever before.

### SUMMARY

A first aspect of the disclosure relates to a randomness processing device, herein referred to as an RPU or "randomness processing unit" that comprises at least a randomness core and a kernel calculations core. These at least two cores are either physically or logically different, and communicate between themselves through a so-called randomness distribution element (ROE). The randomness core (or cores), according to this disclosure, is a specialized device or system designed to handle randomness-related calculations, such as entropy generation, distribution sampling, or correlated random streams. The main, non-limiting focus of these randomness cores is to free other parts of the workload of the computationally intensive burdens related to randomness generation and/or manipulation, and to provide high-quality randomness distributions to the consuming applications, thus improving speed, quality, and efficiency. This allows the offloading of the randomness-intensive workloads to the randomness cores, enabling the usage of the RPU as a hardware accelerator to perform more complex and computationally demanding tasks, analogously as the GPUs freeing the CPUs from rendering tasks.

In some embodiments, the randomness core includes at least one physical entropy source. Examples of these include -but are not limited to- quantum random number generators (QRNGs) or true random number generators (TRNGs). In some embodiments, these randomness cores comprise at least one hardware-implemented sampler. Examples of these include -but are not limited to- an ASIC to generate floating-point random numbers from the randomness source, or an electronic circuit to generate Gaussian numbers from the randomness source. In some embodiments, these randomness cores comprise at least one firmware- or software-implemented sampler. Examples of these include -but are not limited to- an FPGA, and/or an FPGA intellectual property (IP) core to generate floating-point random numbers from the randomness source, or a microcontroller that executes code to generate Gaussian numbers from the randomness source.

The kernel calculations core (also referred to as a kernel core in this document), according to this disclosure, comprises at least one device or system capable of executing at least one workload of interest. In preferred embodiments, these workloads have randomness requirements. Examples of these workloads include -but are not limited to- Monte Carlo simulations, stochastic optimizers, or cryptography cores. In some embodiments, these kernel cores comprise at least one hardware-implemented workload. Examples of these include -but are not limited to- an ASIC that executes cryptographic primitives, or a circuit that performs inference on a neural network. In some embodiments, these kernel cores comprise at least one firmware- or software-implemented workload. Examples of these include -but are not limited to- an FPGA IP core that implements a Monte Carlo sampler, or a processor that implements a stochastic optimization routine.

In some embodiments, the kernel core supports reprogrammability, so that the workload that it executes may be changed at will by the end user and/or by another device that could be communicatively coupled with the core or the RPU. Examples of the kernel core include -but are not limited to- a cryptographic primitive core that changes the computational security parameters under request by the end user or a Monte Carlo sampler whose sampling distribution can be configured by the end user.

In some embodiments, the kernel core supports the execution of a given instruction set, so the workload it executes may be expressed as a program using this given set of instructions. Examples of these include -but are not limited to- using softcore or hardcore processors as kernel cores.

The randomness distribution element (ROE), according to this disclosure, comprises at least one element that allows interconnection between either at least one of the randomness cores and at least one of the kernel cores. In some embodiments, the role of this ROE is played by the cache/memory/storage hierarchy. Examples of these include, but are not limited to, static random access memory (SRAM) caches, random-access memory (RAM), and solid-state drives (SSDs). In some embodiments, the role of this ROE is played by the internal network interconnects of the implemented device. Examples of this include, but are not limited to, interconnections within an FPGA, or a NoC, or an ASIC, or memory buffers between an entropy source and a processor.

In some embodiments, all devices and systems comprising the RPU are integrated within the same device. Examples of these include, but are not limited to, specifically-tailored silicon devices, such as ASICs or other kinds of integrated circuits (ICs). In some embodiments, the elements comprising the RPU are made of different types of hardware. Examples of these include, but are not limited to, a photonic entropy source together with an FPGA implementing the randomness cores and a CPU implementing the kernel cores.

As a non-limiting example implementation, in some embodiments, the RPU comprises a two-core processor, which shares a low-hierarchy memory between the processors. One of the cores may serve as the randomness core in this embodiment. In contrast, the other core may serve as the kernel core for the computation. The low-hierarchy memory plays the role of the randomness distribution element, sending the results from the randomness core to the kernel core. In some other embodiments, the RPU comprises at least one processor with more than two cores.

Another non-limiting example implementation is the combination of a CPU, such as a single-core CPU, with a separated random number generator device, the latter being, for example, a pseudo-random number generator, a physical entropy source, or a suitable combination of both. In this case, the CPU (e.g., single-core CPU) only contains the kernel core, with the randomness core being the RNG device.

More complex, non-limiting example implementations may require alternative hardware devices to a CPU. For example, an RPU architecture may be implemented within a GPU, with one/multiple blocks/threads specializing in the randomness generation part. In contrast, the other blocks/threads may specialize in the execution of the kernel cores.

Another non-limiting example implementation is the combination of a field-programmable gate array (FPGA) with a separated random number generator device. In this case, the FPGA may contain both the required logic for the control of the device and all/part of the kernel core computations.

In some embodiments, the randomness and the kernel cores are in different devices: for example, part of the FPGA may also implement the randomness calculation cores, and other elements implement the kernel cores, with the FPGA connectivity devices acting as the randomness distribution elements.

In some embodiments, the dedicated areas for the randomness and the kernel cores may not be monolithic. For example, in implementations, these areas may be intertwined within the FPGA/silicon device so that locality is considered when performing the overall computation.

In some embodiments, the RPU device may be combined with other accelerators to maximize the overall performance. As a non-limiting example, the RPU device may be connected with a GPU device in the same card, the latter requesting part of the calculation from the RPU and further post-processing it. The GPU device(s) may also be substituted by CPUs, TPUs, FPGAs, ASICs, or any suitable combination of these, either as a pipeline, parallel architecture, or displayed in any appropriate hierarchy.

Another aspect of the disclosure relates to a field-programmable gate array configured to simulate at least one RPU, as described in the first aspect.

Another aspect of the disclosure relates to an integrated circuit board assembly, comprising: at least one RPU as described in the first aspect; a data communications interface for communications between at least said computing device or system and a host device or system; a power supply connection, to receive electrical power for operating said integrated circuit board; a software driver, executable by the host device or system, configured to manage interactions between said computing device or system and said integrated circuit board assembly, said software driver including instructions for utilizing said device or system for processing tasks designated by said computing device.

Another aspect of the disclosure relates to a method for post-processing random numbers using an RPU device. It is one purpose of this disclosure to provide a hardware accelerator with better performance with respect to, e.g., general-purpose computing devices, such as CPUs, in speed, throughput, capacity, quality, and/or energy efficiency and is an enabling component for randomness-intensive workloads. Potential applications and use cases for the matter of this disclosure include, but are not limited to, key generation or algorithm acceleration in cryptography, Monte Carlo simulations or heuristic optimization in finance, route optimization, and inventory management in logistics, supply chain, grid optimization, and risk evaluation in energy, genomic analysis in healthcare, synthetic data generation and neural network training in machine learning, atomic system simulation or weather forecast in scientific computing, among others.

Overall, the disclosure addresses the limitations of existing solutions in the field of hardware accelerators when it comes to calculating randomness-intensive workloads and provides a more effective and efficient solution for performing such computations.

The details of the present disclosure, both as to its structure and operation, can best be understood in reference to the accompanying drawings, in which like reference numerals refer to like parts.

### BRIEF DESCRIPTION OF THE DRAWINGS

FIG. 1 shows an abstract scheme of a randomness processing unit (RPU) device or system.

FIG. 2 shows an example embodiment of an RPU, comprising two different cores within a CPU device or system.

FIG. 3 shows an example embodiment of an RPU, comprising multiple different cores within a device or system.

FIG. 4 shows an example embodiment of an RPU, comprising multiple different cores within a GPU device or system.

FIG. 5 shows an example embodiment of an RPU, comprising a heterogeneous combination of different computing devices or systems.

FIG. 6 shows an example embodiment of an RPU, in which multiple randomness cores and kernel cores are intertwined together to maximize locality and throughput.

FIG. 7 shows an example embodiment of an RPU, in which the concepts of FIGS. 5 and 6 are combined together.

### DETAILED DESCRIPTION

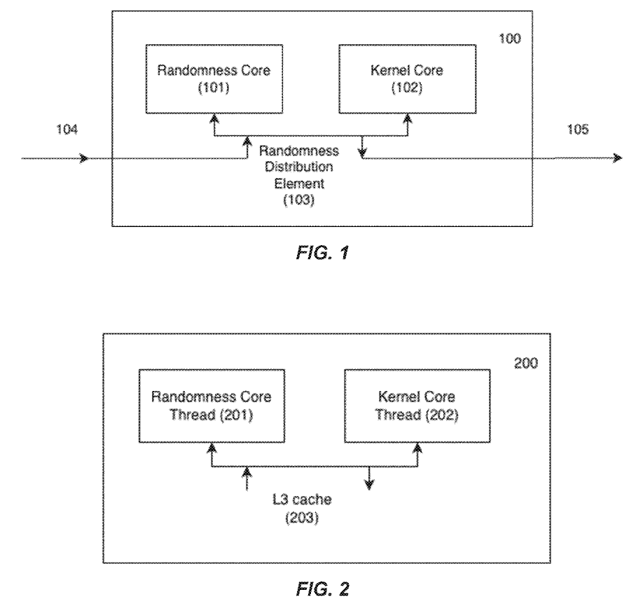

FIG. 1 shows a general scheme of embodiments of this disclosure. In this general scheme, the randomness processing unit (RPU) 100 comprises a randomness core 101 and a kernel core 102, which communicate via a randomness distribution element 103.

Schematic 100 shows a single randomness core, a single kernel, and a single randomness distribution element. However, other embodiments include more than one randomness core, and/or more than one kernel, and/or more than one randomness distribution element. As non-limiting examples, some embodiments include multiple kernels that leverage the results from a single randomness core; other embodiments include multiple randomness cores providing their output data to a single kernel.

In some embodiments, the randomness core 101 comprises a random number generator (RNG) device or system, which generates random numbers under a given distribution. In some embodiments, the distribution is a uniform distribution, namely a floating point uniform distribution, over a given range [a,b), for example [O,1), or [-1,1). In some embodiments, the distribution is a Gaussian distribution of a given mean and standard deviation.

Examples of these RNGs include, but are not limited to: pseudorandom number generators (PRNGs), such as linear congruential generators, Mersenne Twister, or Xorshift Generators; true random number generators (TRNGs), such as avalanche noise generators, ring-oscillator-based RNGs, thermal- or shot noise-based TRNGs, or analog generators; hardware random number generators (HRNGs) such as physical unclonable functions, timing jitter-based generators, electronic noise-based generators, or chaos-based generators; quantum random number generators (QRNGs), such as phase-diffusion, or VCSELS-based QRNGs; other entropy sources, such as sensor data, radioactive decay detector, or human input processors; cryptographic RNGs, designed specifically for cryptographic applications, and compliant with cryptographic standards such as NIST SPS00-90 and BSI AIS-31.

In some embodiments, the randomness core 101 combines the outputs of any of these RNG devices. As a non-limiting example, a cryptographic PRNG output is combined with an HRNG output, to ensure that any failures in the HRNG do not drastically reduce the randomness core output quality.

In some embodiments, the randomness core 101 comprises an implementation of methods for post-processing the random numbers. As a non-limiting example, a randomness core includes a QRNG together with a post-processing function that maximizes the entropy per bit of the output. Examples of these post-processing functions include, but are not limited to, hash functions such as SHA-2 and SHA-3; whitening algorithms such as XORing and bit-shuffling; matrix transformations and/or error correction codes like Reed-Solomon encoding, among others. These post-processing methods are crucial for ensuring that the raw random data is transformed into a highly unpredictable and statistically robust sequence of random bits, suitable for a wide range of cryptographic and security-sensitive applications.

In some embodiments, the input to the randomness core 101 is provided by an RNG device or system. In some embodiments, the input to the randomness core 101 is provided by another randomness core 101. In some embodiments, the input to the post-processing device or system is provided externally, for example, through the RPU input port.

In some embodiments, the randomness core 101 comprises an implementation of methods for post-processing the random numbers, with purposes other than increasing the robustness of the random stream. Examples of these methods include, but are not limited to, the generation of floating-point representation of the numbers starting from an integer or bitwise representation of the random numbers. In some embodiments, this floating-point representation is one of the IEEE-753 floating point types; for example, the 16-, 32-, and 64-bit floating-point representation. In some embodiments, this floating-point representation is a bfloat of arbitrary precision; for example, an 8-bit or a 16-bit bfloat.

In some embodiments, the randomness core 101 comprises a sampler device or system. A purpose of this sampler is to generate samples from a given statistical distribution. In some embodiments, the input to the sampler is provided by an RNG device or system. In some embodiments, the input to the sampler is provided by another randomness core. In some embodiments, the input to the post-processing device or system is provided by a post-processing device or system. In some embodiments, the input to the post-processing device or system is provided by another sampler device or system. In some embodiments, the input to the sampler is provided externally, for example, through the RPU input port.

In some embodiments, the sampled distribution is a continuous distribution. Examples of these continuous distributions include, but are not limited to: uniform distributions in ranges such as [0,1), [-1,1], [0, 2AN), [2A(N-1), 2A(N-1) ); normal (gaussian) distributions with means and standard deviations such as (0,1); exponential distributions with rate parameters like 1 or 0.5; gamma distributions with shape and scale parameters such as (2,1); beta distributions with alpha and beta parameters such as (2,5), and chi-square distributions of different degrees of freedom, such as 1 or 2. Other continuous distributions include, but are not limited to: Cauchy, log-normal, Weibull, F-distribution, Pareto, triangular, Dirichlet, Gumbel, Laplace, and Student's t-distribution.

In some embodiments, the sampled distribution is a discrete distribution. Examples of these include, but are not limited to: Bernoulli distributions with probability of success like 0.5; binomial distributions with number of trials and probability of success like (10, 0.5); and Poisson distributions with a rate parameter like 1 or 5. Other discrete distributions include, but are not limited to: geometric, negative binomial, hypergeometric, multinomial, discrete uniform, Zipf's distribution, and categorical distributions.

In some embodiments, the sampled distribution is a multivariate distribution. Examples of these include, but are not limited to: multivariate normal distribution with a given mean vector and covariance matrix; Wishart distributions with given degrees of freedom and scale matrix parameters; multivariate Bernoulli distributions; and Dirichlet-multinomial distributions.

In some embodiments, the sampled distribution is a special kind of distribution. Examples of these include, but are not limited to: the generation of copulas with given correlation structures, generation of mixture models combining multiple underlying distributions, Markov chains with specific transition matrices, and hidden Markov models with given state transition and emission probabilities.

In some embodiments, the sampler implements specific sampling methods. Examples of these include, but are not limited to: the inverse transform method; the Von Neumann rejection method; the importance sampling method; stratified sampling; Markov-Chain Monte Carlo methods, such as Metropolis-Hasting or Gibbs sampler; and Sequential Monte Carlo methods.

In some embodiments, the sampled distribution is returned in fixed-point form. As a special case of this, in some embodiments the sampled distribution is returned in an integer range, such as [0,2AN), or [-2A(N-1), 2A(N-1) ). In some embodiments, the sampled distribution is returned in floating-point form. Examples of this format include, but are not limited to; the IEEE-753 floating point types, for example, the 16-, 32-, and 64-bit floating-point representation; bfloats of arbitrary precision, for example, an 8-bit or a 16-bit bfloat.

In some embodiments, some or all the randomness core elements are implemented as hardware-specialized devices or systems. A purpose of these embodiments is to benefit from the efficiency resulting from a tailored hardware implementation of the algorithms. Examples of these embodiments include, but are not limited to, a QRNG together with an ASIC for sampling normal numbers in floating-point form. In this specific example, the ASIC implements the control logic for the QRNG, a method for the generation of floating-point numbers from the QRNG random stream, and a method for generating floating-point normal random numbers.

In some embodiments, some or all the randomness core elements are implemented as firmware or software cores, to be executed into hardware devices or systems. A purpose of these embodiments is to benefit from the flexibility resulting from a firmware- or software implementation of the algorithms, while still providing reasonable efficiency. Examples of these embodiments include, but are not limited to, a QRNG together with an FPGA that implements the sampling of normal numbers in floating-point form. Another example of this embodiment is a QRNG together with a microprocessor, which has an instruction set architecture (ISA) that contains specific instructions for randomness generation and a program that leverages those instructions within the ISA to improve performance in the randomness-intensive parts of the execution. Examples of these ISAs include, but are not limited to, RISC-V ISA with custom extensions.

The kernel core 102, according to this disclosure, comprises at least one device or system capable of executing at least one workload of interest. In preferred embodiments, these workloads have randomness requirements, and the randomness cores provide the randomness to the kernels via the randomness distribution element. Examples of these workloads include -but are not limited to- Monte Carlo simulations, stochastic optimizers, or cryptography cores.

In some embodiments, these kernel cores 102 comprise at least one hardware-implemented workload. Examples of these include, but are not limited to: an ASIC that executes cryptographic primitives for encryption/decryption or digital signature; a computing device that performs inference on neural network; a digital signal processor (DSP) which requires results from a Monte Carlo simulation to operate.

In some embodiments, these kernel cores 102 comprise at least one firmware- or software-implemented workload. Examples of these include, but are not limited to: a GPU that implements random matrix multiplications, whose coefficients are required to have a given structure; an FPGA IP core that implements a Monte Carlo sampler, such as a Metropolis-Hasting method; a processor that implements a stochastic optimization routine, such as a genetic algorithm, or an Ant Colony Optimization algorithm.

In some embodiments, the kernel cores 102 support reprogrammability, so that the workload that they execute may be changed at will by the end user. Examples of these include -but are not limited to- a cryptographic primitive core that changes the computational security under request by the end user, such as the computational security parameters under request, or a Monte Carlo sampler whose sampling distribution can be configured at will by the end user.

In some embodiments, the kernel cores 102 support the execution of a given instruction set, so the workload they execute may be expressed as a program using this given set of instructions. Examples of these include -but are not limited to- using softcore or hardcore processors as kernel cores.

The randomness distribution element (ROE) 103, according to this disclosure, comprises at least one interconnection between at least one of the randomness cores and at least one of the kernel cores. In some embodiments, the role of this ROE 103 is played by the internal network interconnects of the implemented device. Examples of this include, but are not limited to, 12 interconnections within an FPGA, or a NoC, or an ASIC, or memory buffers between an entropy source and a processor. In some embodiments, the role of this ROE 103 is played by different levels of memory hierarchy. Examples of this include, but are not limited to, storage devices, DOR or HBM memory modules, or different levels of cache memory.

In some embodiments, a control device or system controls the data flows within the ROE 103. In some of these embodiments, the control device reconfigures the layout of the ROE, either static or dynamically, modifying the data flow to better execute the workloads at hand being executed by the RPU elements.

The RPU device comprises an input port, device, or system 104 that feeds the required data and instructions into the randomness cores, the kernels, and the randomness distribution element. In some embodiments, the input 104 comprises a memory mapped interface, such as direct memory access, remote direct memory access, or shared memory. In some embodiments, the input comprises a stream interface. In some embodiments, this interface is a cascade interface.

The RPU device comprises an output port, device, or system 105 that returns the processed data from the randomness cores, the kernels, and the randomness distribution element. In some embodiments, the output comprises a memory-mapped interface, such as direct memory access, remote direct memory access, or shared memory. In some embodiments, the output comprises a stream interface. In some embodiments, this interface is a cascade interface.

In some embodiments, the input 104 and the output 105 interfaces are shared. Examples of this include, but are not limited to, a direct memory access interface with a high-bandwidth memory (HBM) device or system, or a peripheral component interconnect express (PCIe) interface.

The RPU device or system 100 has broad applications across various industrial verticals. Following, we provide a non-limiting list of different applications across different sectors.

In scientific research and development, the device or system 100 is applied in climate modeling and in pharmaceuticals & genetics. In this context, it assists supercomputing environments simulating climate patterns and changes, drug discovery, and genetic research involving randomness, like random mutations and protein folding simulations.

In cybersecurity, the device or system 100 finds its application in cryptographic activities, aiding servers in managing SSL/TLS encryption protocols. Furthermore, the RPU device 100 is applied in workstations for cryptographic research, development, and randomness-intensive penetration testing.

For the manufacturing sector, the device or system 100 is applied in quality control processes and supply chain optimization. Here, servers utilize the device for random sampling techniques in quality assurance and for stochastic optimization in supply chain logistics.

In telecommunications, the device or system 100 aids in network optimization processes, specifically in the management and optimization of traffic flows within network infrastructures.

In the healthcare sector, the device or system 100 is used in medical imaging and clinical trials, assisting workstations and servers in applying stochastic methods for medical image analysis and in the random assignment and analysis of clinical trial participants.

In the financial sector, the RPU 100 is applied in algorithmic trading, aiding in the development and testing of trading strategies by quantitative analysts. It is also applied in risk analysis where servers utilize the device for calculations related to financial portfolio risks using stochastic methods such as Monte Carlo simulations.

Within the gaming industry, the device or system 100 is used in game and game development workstations for creating games with random environments and Al behaviors. It is also applied in servers that host multiplayer online games with random environmental events.

In the entertainment and media domain, the device or system 100 is used in render farms for film and animation production, particularly for generating stochastic effects, such as simulating weather patterns, crowd behaviors, and natural phenomena.

For the education domain, the device or system 100 is applied in online learning platforms where servers use it for the random generation of educational assessments such as quizzes and examination papers.

In retail, the device or system 100 aids recommendation systems, helping servers execute randomness-intensive algorithms for product recommendation generation, or for data augmentation.

The device or system 100 is also applicable in edge computing, especially in scenarios involving Internet of Things (IoT) devices, aiding in real-time decision-making for devices operating at network edges, like traffic management systems and smart home devices. The device or system 100 is applied in hyperscale data centers where randomness assists in optimizing workload distributions and resource allocations.

To fulfill these applications, the RPU device or system 100 has to be integrated within the existing IT infrastructure. In some embodiments, the device or system 100 is used in various infrastructures for randomness-focused computations. Examples of these include, but are not limited to, standalone servers, virtual machines, and container-based systems like Docker and Kubernetes. Other non-limiting examples include: serverless settings, where it processes randomness-heavy computations; security tools; loT edge devices; workstation computers; high-performance computing clusters; and cloud service systems, for handling tasks centered around randomness.

FIG. 2 illustrates one embodiment of the RPU concept. In this embodiment, a dual-core CPU is configured to follow the RPU architecture described in FIG. 1. One of the cores 201 acts as a randomness core 101, whereas the other core 202 acts as the kernel core 102. The role of the randomness distribution element 103 is performed in this case via the different cache, memory, and storage hierarchies, such as for example a shared L3 cache 203 between the two cores.

In some embodiments, the embodiment of FIG. 2 is straightforwardly generalized to CPUs with more than two cores, where N cores split between them the roles of randomness core 201 and kernel cores 202. In some embodiments, this splitting is equal, having N/2 randomness cores 201 and N/2 kernel cores 202. In some embodiments, there is only one randomness core 201, and N-1 kernel cores 202.

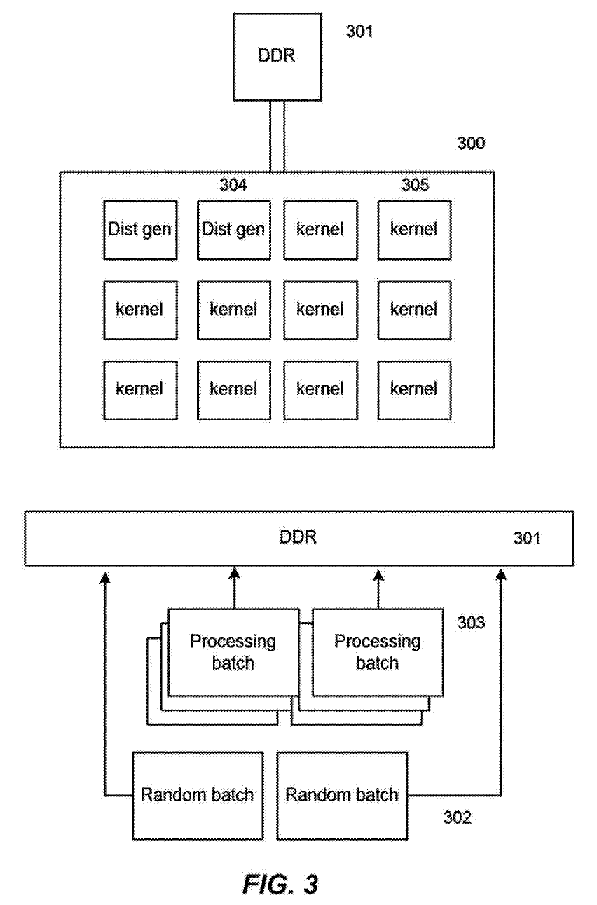

FIG. 3 illustrates another embodiment of the RPU concept. In this embodiment, the RPU 300 is connected to a cache/memory/storage medium 301, which is used as buffer in between the different cores 304, 305, comprising the RPU architecture.

In some embodiments, the RPU device 300 is implemented in computing devices including -but not limited to- CPUs, GPUs, FPGAs, complex programmable logic devices (CPLDs), or ASICs.

In some embodiments, the cache/memory/storage medium 301 comprises, in a non-limiting sense, SRAM caches, RAM memories, or SDDs. In some embodiments, the RPU device 300 is configured to deliver the output 302 from the randomness cores 304 and the output 303 from the kernel cores 305 in and out of the memory 301.

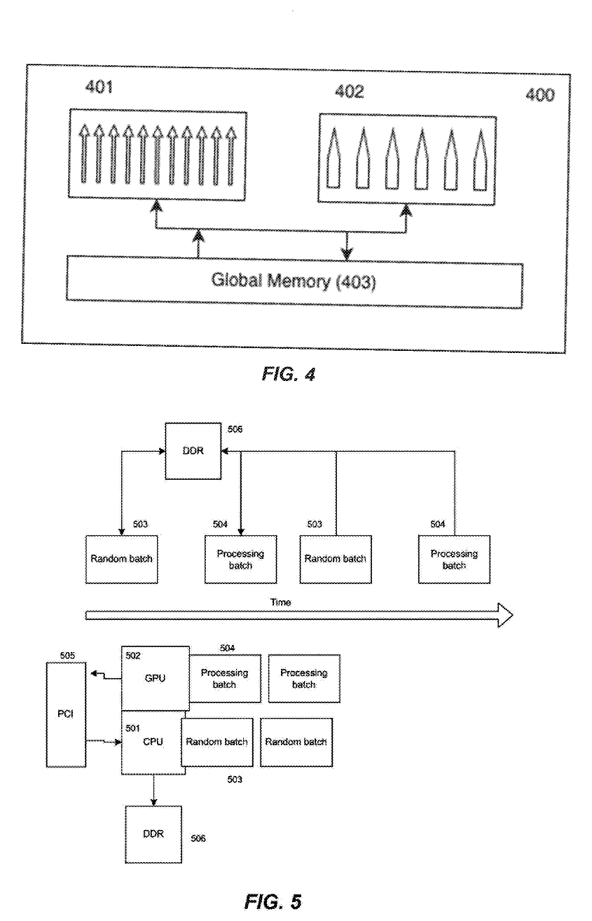

FIG. 4 illustrates another embodiment of the RPU concept. In this embodiment, a GPU 400 is configured such that at least one block of threads 401 behave as a randomness core 101, whereas the other available blocks 402 behave as kernel cores 202. The role of the randomness distribution element 103 in this place is performed in this case by the different cache, memory, and storage hierarchies, such as for example the global GPU memory 403 of the local block memory, for intra-block communications.

In some embodiments, the GPU comprises different program counters for the kernel and the randomness core configurations, thus enabling these to not depend on the same program counter and, thus, improve the overall throughput and/or performance of the configured GPU device.

FIG. 5 illustrates another embodiment of the RPU concept. In this embodiment, the RPU architecture comprises the combination of a CPU 501, which is configured to run as the randomness core, generating the random batches 503 or tasks in the process, and a GPU 502, which is configured to execute the kernel cores, generating the results 504 in the process. The randomness distribution element 103, in this embodiment, is identified with an internal cache/memory 506.

In some embodiments, the device or system comprises a data connection to the host device 505. Examples of these data connections include, but are not limited to, PCle, Ethernet, or Thunderbolt interfaces.

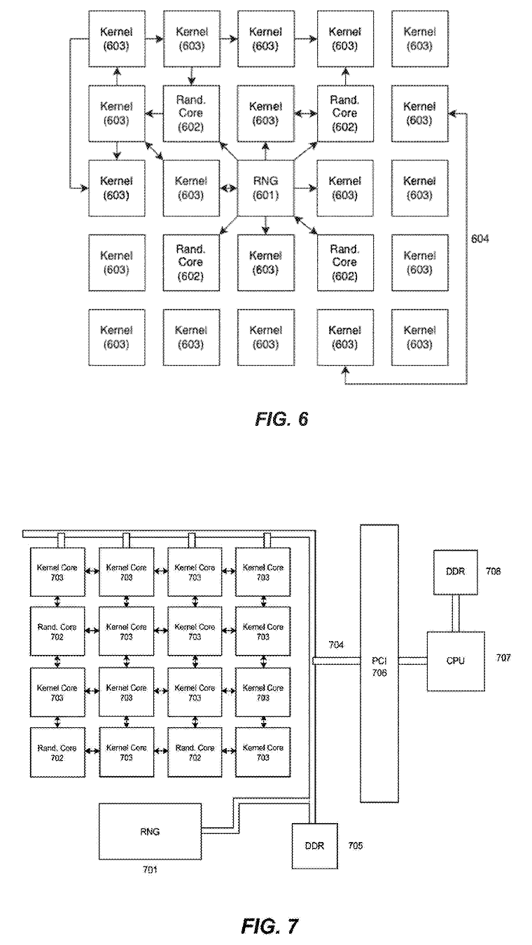

FIG. 6 illustrates one of the potential arrangements of the different RPU cores within a device. In this embodiment, there are two different kinds of randomness cores 101: the RNG cores 601 and the distribution cores 602.

In this embodiment, the RNG cores 601 are configured to generate uniform random numbers from a given distribution. In some embodiments, this is a uniform integer distribution of a given size, including -but not limited to- 16, 32, 64, and 128-bits.

The random numbers are transferred via the randomness distribution cores to either the distribution cores 602, or directly to the kernel cores 603 for consumption. In the first case, the results are further post-processed before being fed to the kernel. Examples of these include, but are not limited to, the generation of a given distribution or being used within a Monte-Carlo sampler. These post-processed numbers are later transferred to the kernel cores 603.

FIG. 7 illustrates a more complete embodiment of the RPU concept, based on that described in FIG. 6. In this embodiment, the RNG core 701 is isolated from the mesh of randomness cores 702 and kernel cores 703. The randomness distribution element 704 connects together the mesh entities, the RNG core, and any other auxiliary elements of the device. In some embodiments, such mesh has a chessboard shape, so that randomness cores 702 and kernel cores 703 are intertwined between them, fostering the locality of the computation.

In some embodiments, these auxiliary elements comprise a cache, memory, or storage device, including -but not limited to- a DOR memory 705. In some embodiments, these auxiliary elements comprise a communications interface, such as PCl-express 706, to enable communication between the RPU device 700 and the host's CPU 707 and/or memory 708.

In some embodiments, any combination of these auxiliary elements are integrated together in the same integrated circuit board. Examples of these include, but are not limited to, a printed circuit board (PCB) board in a PCle factor.

In some embodiments, the mesh between randomness cores 702 and kernel cores 703 is configured such that it enables the implementation of pipelined workloads, with each of the randomness cores 702 and/or kernel cores 703 executing one part of the pipelined workload before transferring it to the next one in the execution pipeline.

It should be noted that the above-described examples of the present solution are for the purpose of illustration. Although the solution has been described in conjunction with specific examples thereof, numerous modifications are possible without materially departing from the teachings of the subject matter described herein. Other substitutions, modifications and changes may be made without departing from the spirit of the present solution. It should also be noted that, in the context of the present disclosure, functions described with reference to particular devices or systems refer, in embodiments, to the devices or systems being configured to conduct the functions.

All of the features and applications disclosed in the present disclosure (including any accompanying claims, abstract and drawings), and/or all of the parts of any method or process so disclosed, may be combined in any combination, except combinations where at least some of such features and/or parts are mutually exclusive.

1. A computing device or system, comprising:
a) a randomness core,
b) a kernel core,
c) a randomness distribution element,
wherein the randomness core is configured to deliver a random number to the randomness distribution element,
wherein the randomness distribution element is configured to deliver the random number to the kernel core, and
wherein the kernel core is configured to include the random number into a computational workload.

2. The computing device or system of claim 1 , wherein the kernel core is configured to be reprogrammed according to a computational workload under execution of the computational workload.

3. The computing device or system of claim 1, wherein the randomness distribution element is configured to be reconfigured according to a computational workload under execution of the computational workload.

4. The computing device or system of claim 1, wherein the randomness core comprises a physical entropy source.

5. The computing device or system of claim 1, wherein the randomness core and the kernel core are arranged according to a mesh distribution.

6. The computing device or system of claim 5, wherein the mesh distribution comprises a chessboard pattern.

7. The computing device or system of claim 1, comprising multiple kernel cores and/or randomness cores pipelined such that they are configured to perform multiple transformations in a sequential manner.

8. The computing device or system of claim 1, wherein the randomness core and the kernel core are two distinct logical or physical elements.

9. The computing device or system of claim 1, wherein the computing device comprises a field-programmable gate array.

10. An integrated circuit board assembly, comprising:
a) a computing device or system according to claim 1,
b) a data communications interface for communications, and
c) a power supply connection, configured to receive electrical power for operating said integrated circuit board assembly.

11. The integrated circuit board assembly of claim 10, wherein the data communications interface follows a PCIe standard.

12. The integrated circuit board assembly of claim 10, further comprising at least one integrated memory and/or storage unit.

13. A method for distribution generation, the method comprising:
a. configuring a randomness processing device comprising a randomness core, the randomness core being associated with a predetermined randomness distribution; and
b. requesting a predetermined amount of randomness from the randomness processing device.

14. The method of claim 13, further comprising consuming the randomness via a kernel calculations core of the randomness processing device.

15. The method of claim 14, further comprising arranging the randomness core and the kernel calculations core as two distinct logical or physical elements.

16. The method of claim 13, further comprising:
a. delivering, by the randomness core, a random number to a randomness distribution element of the randomness processing device;
b. delivering, by the randomness distribution element, the random number to a kernel calculations core of the randomness processing device; and
c. including, by the kernel calculations core, the random number into a computational workload.

17. The method of claim 16, further comprising reprogramming the kernel calculations core according to the computational workload.

18. The method of claim 16, further comprising reconfiguring the randomness distribution element according to the computational workload.

19. The method of claim 16, further comprising arranging the randomness core and the kernel calculations core according to a mesh distribution.

20. The method of claim 19, wherein the mesh distribution comprises a chessboard pattern.

21. The method of claim 16, further comprising pipelining multiple kernel calculation cores and/or randomness cores of the randomness processing device to perform multiple transformations in a sequential manner.
